(19) United States
(12) Patent Application Publication
(10) Pub. No.: US 2025/0046291 A1
(43) Pub. Date: Feb. 6, 2025

(54) CANCELLATION APPARATUS, METHOD AND PROGRAM

(71) Applicant: NIPPON TELEGRAPH AND TELEPHONE CORPORATION, Tokyo (JP)

(72) Inventors: Yohei WAKISAKA, Tokyo (JP); Noriyoshi KAMADO, Tokyo (JP); Hiroaki ITO, Tokyo (JP); Shin MURATA, Tokyo (JP)

(73) Assignee: NIPPON TELEGRAPH AND TELEPHONE CORPORATION, Tokyo (JP)

(21) Appl. No.: 18/717,992

(22) PCT Filed: Dec. 14, 2021
(86) PCT No.: PCT/JP2021/045963

§ 371 Date: Jun. 7, 2024

(51) Int. Cl. G10K 11/178

(52) U.S. Cl. CPC G10K 11/17857; G10K 11/17881

(57) ABSTRACT

A cancellation device includes a sound signal processing unit 2 that generates a cancellation signal for suppressing noise acquired by one or more reference microphones 1 for acquiring noise, and one or more cancellation loudspeakers 3 that emit sound on the basis of the cancellation signal. The sound signal processing unit 2 generates the cancellation signal on the basis of sound signals obtained by one or more error microphones 4 disposed in a region where noise is desired to be suppressed, and the one or more reference microphones 1 have directivity and are disposed in the vicinity of the cancellation loudspeakers 3.

### TECHNICAL FIELD

The present invention relates to a technique for suppressing noise in a predetermined region.

### BACKGROUND ART

FIG. 10 illustrates a conventional configuration of active noise suppression (feedforward type) using a cancellation loudspeaker.

The conventional configuration includes a reference microphone P1 that acquires external noise, an ANC processing unit P2 that estimates how the noise acquired from the reference microphone changes at an error microphone position, a cancellation loudspeaker P3 that outputs sound for suppressing the noise, and an error microphone P4 that monitors a suppression state of the noise and feeds the monitoring result back to the ANC processing unit P2.

The error microphone P4 is disposed in a region PR where noise is desired to be suppressed. An enclosure loudspeaker is used as the cancellation loudspeaker P3.

Passive noise suppression is less effective for noise suppression in a wide band. Therefore, active noise suppression (feedforward type) is effective for noise suppression in a wide band.

In active noise suppression (feedforward type), it is known that when the distance between the reference microphone P1 and the error microphone P4 is short, the amount of noise suppression can be increased and the suppression noise band can be widened.

### CITATION LIST

### Non Patent Literature

[NPL 1] Kajikawa, “Recent Topics and Applications of Active Noise Control,” Research Report Music Information Science (MUS), vol. 2015-MUS-107, No. 3, pp. 1-6, May 2015.

### SUMMARY OF INVENTION

### Technical Problem

In the related art, when the reference microphone P1 and the error microphone P4 are brought close to each other, the suppression sound output from the cancellation loudspeaker P3 is input to the reference microphone P1 together with noise as indicated by an arrow of an alternate long-and-short dashed line in FIG. 10. Therefore, in the related art, when the reference microphone P1 and the error microphone P4 are brought close to each other, howling occurs and stable operation cannot be achieved. In other words, in the related art, when the reference microphone P1 and the error microphone P4 are brought close to each other, noise suppression performance may deteriorate.

An object of the present invention is to provide a cancellation device, method, and program having higher noise suppression performance than before.

### Solution to Problem

A cancellation device according to an aspect of the present invention is a cancellation device including: a sound signal processing unit configured to generate a cancellation signal for suppressing noise acquired by one or more reference microphones for acquiring noise; and one or more cancellation loudspeakers configured to emit sound on the basis of the cancellation signal, in which the sound signal processing unit generates the cancellation signal on the basis of sound signals obtained by one or more error microphones disposed in a region where noise is desired to be suppressed, and the one or more reference microphones have directivity and are disposed in the vicinity of the cancellation loudspeakers.

### Advantageous Effects of Invention

Noise suppression performance can be made higher than before while achieving a stable operation.

### BRIEF DESCRIPTION OF DRAWINGS

FIG. 1 is a diagram illustrating an example of a functional configuration of a cancellation device.

FIG. 2 is a diagram illustrating an example of a processing procedure of a cancellation method.

FIG. 3 is a diagram for describing an enclosure-less loudspeaker.

FIG. 4 is a perspective view of an example of an enclosure-less loudspeaker.

FIG. 5 is a front view of the example of the enclosure-less loudspeaker.

FIG. 6 is a left side view of the example of the enclosure-less loudspeaker.

FIG. 7 is a plan view of the example of the enclosure-less loudspeaker.

FIG. 8 is a rear view of the example of the enclosure-less loudspeaker.

FIG. 9 is a diagram illustrating a functional configuration example of a computer.

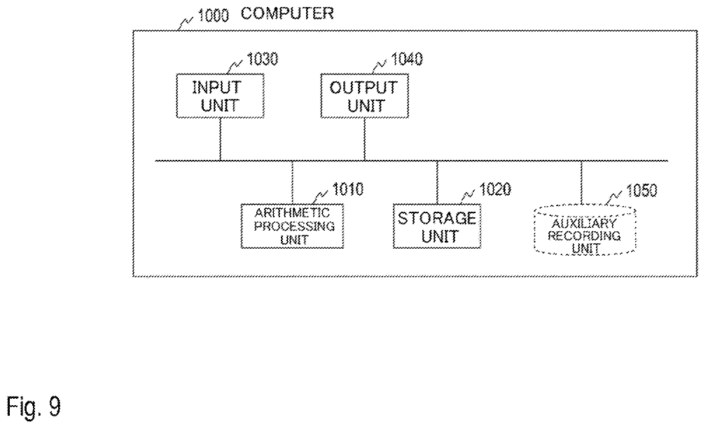

FIG. 10 is a diagram for describing the background art.

### DESCRIPTION OF EMBODIMENTS

Hereinafter, embodiments of the present invention will be described. In the drawings, components having the same functions are denoted by the same reference numerals, and redundant description thereof will be omitted.

### [Cancellation Device and Method]

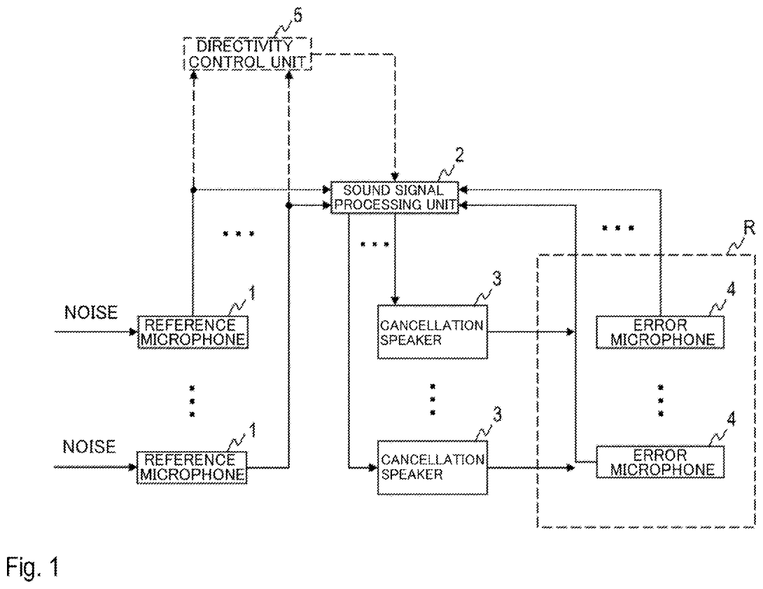

As illustrated in FIG. 1, a cancellation device includes a sound signal processing unit 2 and one or more cancellation loudspeakers 3. The cancellation device may further include one or more reference microphones 1, one or more error microphones 4, and a directivity control unit 5.

In FIG. 1, two or more reference microphones 1, two or more cancellation loudspeakers 3, and two or more error microphones 4 are depicted. However, each of the number of reference microphones 1, the number of cancellation loudspeakers 3, and the number of error microphones 4 may be one.

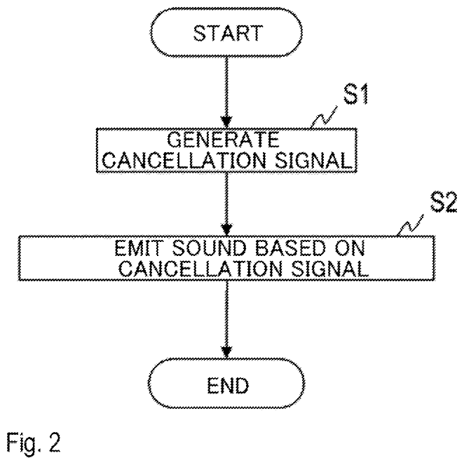

A cancellation method is implemented, for example, by each component of the cancellation device performing processing of steps S1 and S2 illustrated in FIG. 2, which will be described below.

Each component of the cancellation device will be described below.

### <Reference Microphone 1>

The reference microphone 1 is a microphone for acquiring noise. A noise signal which is a signal of noise acquired by the reference microphone 1 is output to the sound signal processing unit 2.

The reference microphone 1 has directivity and is disposed in the vicinity of the cancellation loudspeaker 3.

When the cancellation device includes the directivity control unit 5, the directivity of the reference microphone 1 is achieved by, for example, processing of the directivity control unit 5, which will be described later. The directivity of the reference microphone 1 may be achieved by the function of the reference microphone 1 itself.

That is, it is assumed that the term “has directivity” includes the two types of the case where a microphone as a whole has directivity by applying signal processing to the signals obtained by sound collection with a plurality of omnidirectional microphones and the case where a microphone itself has directivity as its characteristic. The type of directivity of the reference microphone 1 is not limited to these two types.

Here, “the microphone has directivity in a certain direction” means that a gain when collecting sound arriving at the microphone from the certain direction is larger than a gain when collecting sound arriving at the microphone from a direction different from the certain direction.

Details of the directivity of the reference microphone 1 will be described later.

### <Sound Signal Processing Unit 2>

The sound signal processing unit 2 generates a cancellation signal for suppressing noise acquired by one or more reference microphones 1 (step S1). The generated cancellation signal is output to the cancellation loudspeaker 3.

The sound signal processing unit 2 corresponds to an ANC processing unit P2 of the background art. That is, it can be said that the sound signal processing unit 2 performs processing for estimating how the noise acquired by the reference microphone 1 changes at the position of the error microphone 4.

More specifically, the sound signal processing unit 2 generates a cancellation signal for suppressing noise on the basis of a sound signal obtained by one or more error microphones 4.

### <Cancellation Speaker 3>

The cancellation loudspeaker 3 emits sound on the basis of the cancellation signal (step S2). The cancellation loudspeaker 3 may be an enclosure-less loudspeaker or an enclosure loudspeaker similar to the background art. The enclosure-less loudspeaker will be described later.

### <Error Microphone 4>

The error microphone 4 is a microphone disposed in a region R where noise is desired to be suppressed. The sound signal obtained by the error microphone is output to the sound signal processing unit 2.

For example, when it is desired to suppress noise in a region around the head of a certain person, the region around the head of the person becomes the region R where noise is desired to be suppressed.

It can also be said that the error microphone 4 acquires the suppression effect.

### <Directivity Control Unit 5>

When the cancellation device includes the directivity control unit 5, a sound signal which is a signal of sound acquired by the reference microphone 1 is input to the sound signal processing unit 2. The sound signal may include a noise signal.

The directivity control unit 5 controls the directivity of the reference microphone 1 on the basis of the sound signal acquired by the reference microphone 1, for example, as described later in [Directivity of Reference Microphone 1].

For example, when the number of reference microphones 1 is two or more, a control signal for filter processing for controlling directivity of a sound signal acquired by each reference microphone 1 is generated and output to the sound signal processing unit 2. The sound signal processing unit 2 performs filter processing on the sound signal acquired by each reference microphone 1 on the basis of the control signal. The sound signal processing unit 2 performs the above sound signal processing on the filtered signal. When the number of reference microphones 1 is two or more, for example, the directivity control unit 5 controls the directivity of the reference microphones 1 in this way.

When the number of reference microphones 1 is one, the directivity control unit 5 may control the directivity of the reference microphone 1 by physically changing the direction and position of the reference microphone 1.

The directivity control unit 5 may be capable of estimating the direction of arrival of the sound signal.

When the error microphone 4 and the reference microphone 1 are installed close to each other, the reference microphone 1 is disposed in the vicinity of the cancellation loudspeaker 3 to give directivity to the reference microphone 1, thereby making it difficult to input the sound emitted by the cancellation loudspeaker 3 to the reference microphone 1. Thus, howling can be suppressed, and noise suppression performance can be improved more than before while achieving stable operation.

### [Directivity of Reference Microphone 1]

An example of setting the directivity of the reference microphone 1 will be described below.

### <When Number of Reference Microphones 1 is One>

When the number of reference microphones 1 is one, the reference microphone 1 is set to have directivity in a direction in which the sound coming from the cancellation loudspeaker 3 is weaker than in a direction in which the sound coming from the cancellation loudspeaker is strong. The setting of the directivity is achieved by, for example, the control of the directivity control unit 5.

When an enclosure-less loudspeaker is used as the cancellation loudspeaker 3, or when the number of the cancellation loudspeakers 3 is two or more, there is a region where the sound emitted by the cancellation loudspeaker 3 is canceled and reduced. In these cases, the reference microphone 1 is disposed in the region, and then the intensity of the sound emitted by the cancellation loudspeaker 3 captured by the reference microphone 1 when the directivity of the reference microphone 1 is directed in each direction is measured. Then, for example, the directivity of the reference microphone 1 is set so that a direction in which the intensity of the sound emitted by the cancellation loudspeaker 3 captured by the reference microphone 1 is the largest becomes null. The directivity of the reference microphone 1 may be set so that the entire direction in which the intensity of the sound emitted by the cancellation loudspeaker 3 captured by the reference microphone 1 is equal to or greater than a predetermined threshold value becomes null.

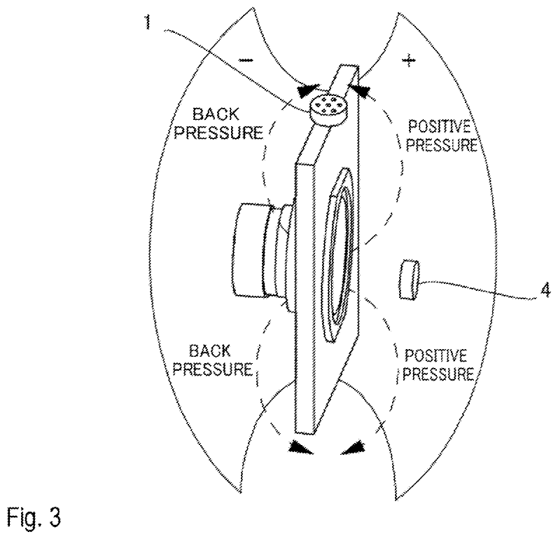

For example, in an enclosure-less loudspeaker using one loudspeaker as illustrated in FIG. 3, which will be described later, it is preferable that the reference microphone 1 be disposed on a plane on which a diaphragm of the enclosure-less loudspeaker is disposed, and that the reference microphone 1 be set to have directivity outside the loudspeaker in a direction parallel to the plane.

When the number of cancellation loudspeakers 3 is two or more, there may occur a plurality of directions in which the sound emitted by the cancellation loudspeakers 3 captured by the reference microphone 1 becomes stronger. In this case, the effect of setting the directivity of the reference microphone 1 is great, for example, as described above.

### <When Number of Reference Microphones 1 is Two or More>

When the number of reference microphones 1 is two or more, all or some of the reference microphones 1 are set to have directivity in a direction in which the sound coming from the cancellation loudspeaker 3 is weaker than in a direction in which the sound coming from the cancellation loudspeaker 3 is strong.

When only some of the reference microphones 1 are set to have directivity in a direction in which the sound coming from the cancellation loudspeaker 3 is weaker than in a direction in which the sound coming from the cancellation loudspeaker 3 is strong, the rest of the reference microphones 1 are set to have directivity in a direction in which the noise arrives. These settings of the directivity are achieved by, for example, the control of the directivity control unit 5.

It is assumed that when N is a positive integer of 2 or more and K is an integer larger than 1 and smaller than N, the number of reference microphones 1 is N. In this case, some of the reference microphone s1 is K reference microphones 1 among N reference microphones 1, and the rest of the reference microphone 1 are N-K reference microphones 1 among the N reference microphones 1 that are not some of the reference microphones 1.

When an enclosure-less loudspeaker is used as the cancellation loudspeaker 3, or when the number of the cancellation loudspeakers 3 is two or more, there is a region where the sound emitted by the cancellation loudspeaker 3 is canceled and reduced.

In these cases, the reference microphones 1 are disposed in the region, and then the intensity of the sound emitted by the cancellation loudspeaker 3 captured by all or some of the reference microphones 1 when the directivity of all or some of the reference microphones 1 is directed in each direction is measured. Then, the directivity of all or some of the reference microphones 1 is set so that a direction in which the intensity of the sound emitted by the cancellation loudspeaker 3 captured by all or some of the reference microphones 1 is the largest becomes null. The directivity of all or some of the reference microphones 1 may be set so that the entire direction in which the intensity of the sound emitted by the cancellation loudspeaker 3 captured by all or some of the reference microphones 1 is equal to or greater than a predetermined threshold value becomes null.

As described above, when only some of the reference microphones 1 are set to have directivity in a direction in which the sound coming from the cancellation loudspeaker 3 is weaker than in a direction in which the sound coming from the cancellation loudspeaker 3 is strong, the rest of the reference microphones 1 may be set to have directivity in a direction in which the noise arrives.

For example, the reference microphones 1 are disposed in a region where the sound emitted by the cancellation loudspeaker 3 is canceled and reduced, and then the intensity of noise captured by the rest of the reference microphones 1 when the directivity of the rest of the reference microphones 1 is directed in each direction may be measured. Then, the rest of the reference microphones 1 may be set to have directivity in a direction in which the intensity of the noise captured by the rest of the reference microphones 1 is the largest, in other words, in a direction of arrival of the noise.

In order to distinguish the sound emitted by the cancellation loudspeaker 3 from the noise, for example, the following method (1) or (2) can be used.

(1) It is assumed that the positions of the reference microphone 1 and the cancellation loudspeaker 3 (in other words, the direction of arrival of the sound emitted by the cancellation loudspeaker 3) and the direction of arrival of the noise are known. In this case, the sound coming from the direction of arrival of the sound emitted by the cancellation loudspeaker 3 can be determined as the sound emitted by the cancellation loudspeaker 3. Also, in this case, the sound coming from the direction of arrival of the noise can be determined as the noise.

(2) An identification model capable of identifying the sound emitted by the cancellation loudspeaker 3 from the noise is learned. In this case, the sound emitted by the cancellation loudspeaker 3 and the noise can be identified by using the learned identification model.

### <Dynamic Control of Directivity of Reference Microphone 1>

The directivity of the reference microphone 1 may be preset before the cancellation device and method are used, or may be dynamically set when the cancellation device and method are used. In other words, the directivity control unit 5 may dynamically control the directivity of the reference microphone 1.

For example, the directivity control unit 5 may estimate the direction of arrival of the sound emitted by the cancellation loudspeaker 3 in real time, and set all or part of the directivity of the reference microphone 1 so that the estimated direction of arrival becomes null.

Further, the directivity control unit 5 may estimate the direction of arrival of noise in real time and set the directivity of the rest of the reference microphones 1 to have directivity in the estimated direction of arrival.

### [Enclosure-Less Speaker]

An example of an enclosure-less loudspeaker will be described below.

The enclosure-less loudspeaker is, for example, a loudspeaker in which a null directional characteristic is formed on the same plane as the diaphragm by not providing a housing.

As illustrated in FIG. 3, the positive pressure emitted to the front of the enclosure-less loudspeaker and the back pressure emitted from the back of the enclosure-less loudspeaker cancel each other at a position on the same plane as the diaphragm of the enclosure-less loudspeaker. Therefore, the sound emitted by the enclosure-less loudspeaker is reduced near the position on the same plane as the diaphragm of the enclosure-less loudspeaker.

An example of the vicinity of the cancellation loudspeaker in which the reference microphone 1 is disposed is a position on the same plane as the diaphragm of the enclosure-less loudspeaker or the vicinity of the position.

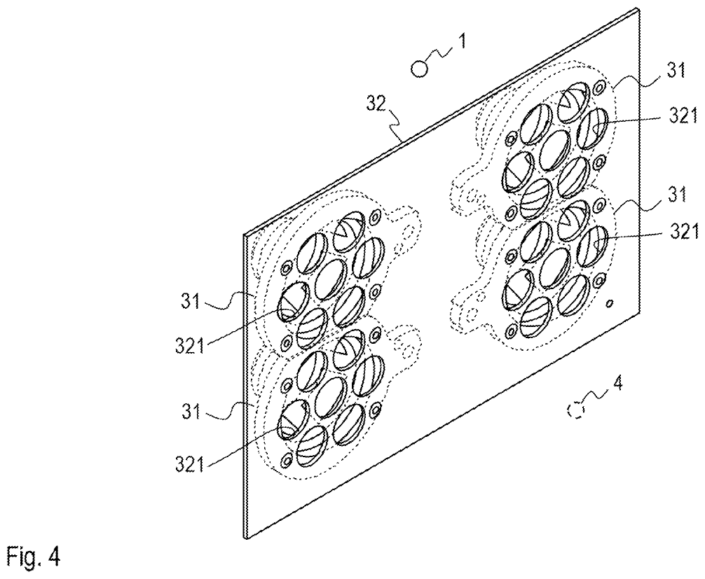

An example of an enclosure-less loudspeaker using a plurality of loudspeakers will be described below. As illustrated in FIGS. 4 to 8, the enclosure-less loudspeaker includes loudspeakers 31 and a fixed plate 32.

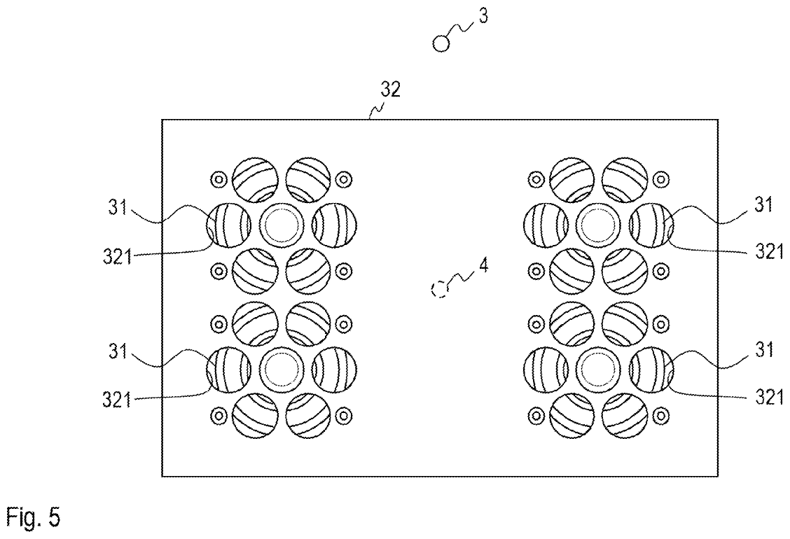

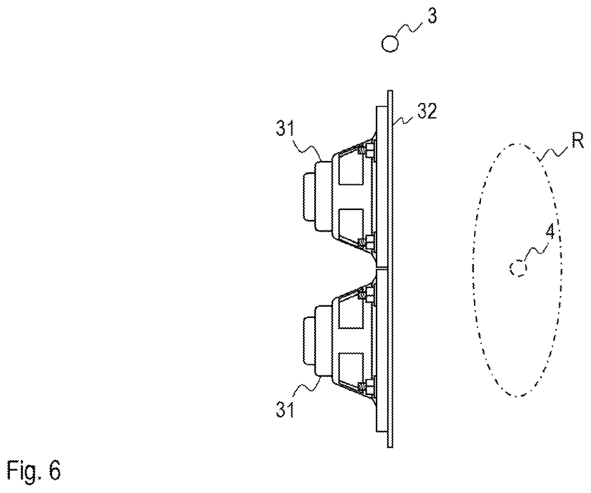

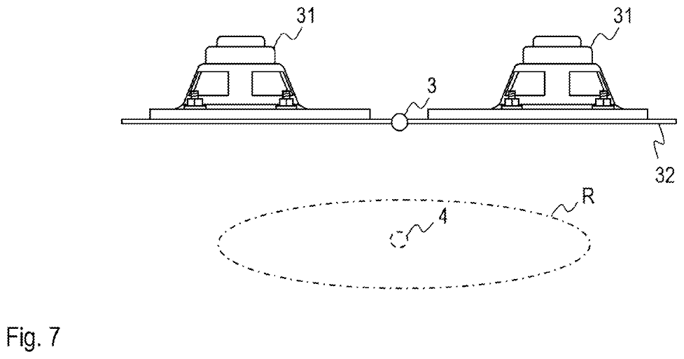

FIG. 4 is a perspective view of an example of an enclosure-less loudspeaker. FIG. 5 is a front view of the example of the enclosure-less loudspeaker. FIG. 6 is a left side view of the example of the enclosure-less loudspeaker. FIG. 7 is a plan view of the example of the enclosure-less loudspeaker.

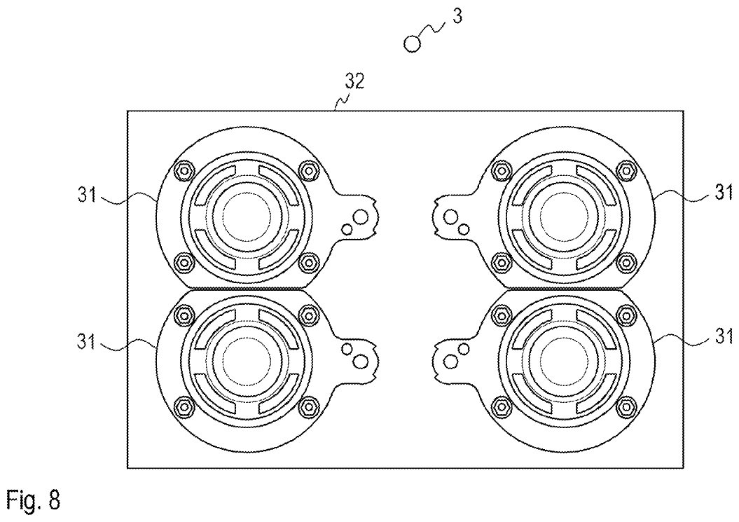

FIG. 8 is a rear view of the example of the enclosure-less loudspeaker.

The fixed plate 32 is made of, for example, aluminum. The fixed plate 32 is provided with sound emitting holes 321. Four loudspeakers 31 are attached to the positions of the sound emitting holes 321 of the fixed plate 32. Note that it is sufficient that at least two loudspeakers 31 are provided. The plurality of loudspeakers 31 are installed on the same plane. For example, the plurality of loudspeakers 31 are on the same plane and are spread evenly in a grid pattern, honeycomb pattern, or the like.

In the examples illustrated in FIGS. 4 to 8, each sound emitting hole 321 is composed of seven holes. The loudspeaker 31 is attached so that the center of the hole at the center of the seven holes coincides with the center of the loudspeaker 31. In the examples illustrated in FIGS. 4 to 8, the loudspeaker 31 is screwed to the fixed plate 32.

If there is a shielding object in the middle of transmission from the loudspeaker 31 to the ear through air, the sound quality may be impaired. In order to avoid this, the sound emitting hole 321 is open.

By disposing the sound emitting holes 321 with high symmetry with respect to the center of the loudspeaker 31, the generated sound field becomes more uniform, and it is more preferable from the viewpoint of sound quality. However, the disposition of the holes is not limited to this example. For example, the sound emitting holes 321 may not be disposed at positions completely symmetrical with respect to the center of the loudspeaker 31. For example, the sound emitting holes 321 may be formed by arranging six holes (one in the center+five in the periphery) in a star shape.

The relationship between the sound emitting hole 321 and the loudspeaker 31 is not particularly limited, but the sound emitting hole 321 is provided at a position close to the loudspeaker 31, for example.

The number and disposition of the sound emitting holes 321 and the loudspeakers 31 are not limited to those described above.

The reference microphone 1 is disposed at a symmetrical position with respect to the plus and minus sound fields generated by the loudspeaker 31. The symmetrical position may be any one of the above-mentioned positions as long as it is on the same plane, but it may be any position as long as it is possible to record sound coming directly from noise (without passing through collision or reflection to various objects in the middle).

In FIGS. 4 to 8, the reference microphone 1 is disposed on the center of the fixed plate 32. The reference microphone 1 is supported by, for example, an elongated body extending from a fixed plate 32. In FIGS. 4 to 8, no elongated body is illustrated.

In other words, in the examples illustrated in FIGS. 4 to 8, the reference microphone 1 is disposed on the same plane as the loudspeaker 31. This plane can be said to be a plane including a boundary between the sound emitting direction of the loudspeaker 31 and the direction opposite to the sound emitting direction. The reference microphone 1 may not be disposed on the loudspeaker 31 as long as the reference microphone 1 is disposed on the same plane as the loudspeaker 31. For example, the reference microphone 1 may be disposed beside the fixed plate 32.

### Modification Example

While the embodiments of the present invention have been described above, specific configurations are not limited to these embodiments, and it is needless to say that appropriate design changes, and the like are included in the present invention without deviating from the gist of the present invention.

The various processes described in the embodiments may be executed not only in chronological order according to the described order, but also in parallel or individually according to the processing capability of a device that executes the processes or as necessary.

For example, data exchange between components of the cancellation device may be performed directly or via a storage unit (not illustrated).

### [Program and Recording Medium]

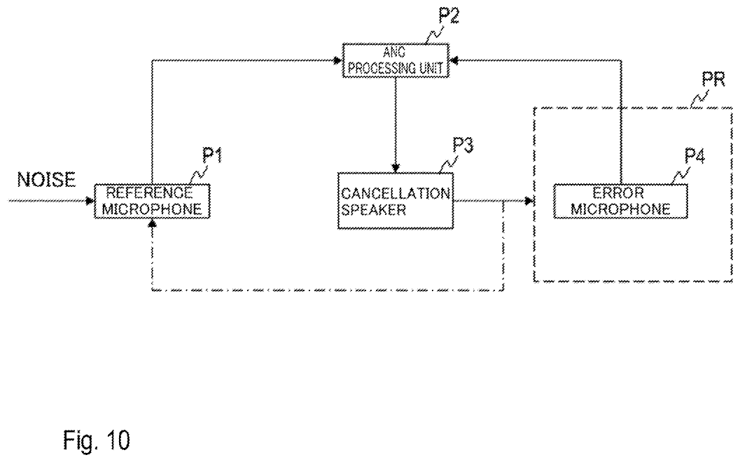

The process of each unit of each of the above-described devices may be implemented by a computer. In this case, processing content of a function of each device is described by a program. The various types of processing functions of each device are implemented on a computer, by causing this program to be loaded onto a storage unit 1020 of a computer 1000, and operating an arithmetic processing unit 1010, an input unit 1030, an output unit 1040, and the like illustrated in FIG. 10.

A program describing the processing content can be recorded on a computer-readable recording medium. The computer-readable recording medium is, for example, a non-transitory recording medium and is specifically a magnetic recording device, an optical disc, or the like.

Also, distribution of the program is performed by, for example, selling, transferring, or renting a portable recording medium such as a DVD and a CD-ROM on which the program is recorded. Further, the program may be distributed by storing the program in a storage device of a server computer and transferring the program from the server computer to other computers via a network.

For example, the computer that performs such a program first temporarily stores the program recorded in a portable recording medium or the program transferred from the server computer in an auxiliary recording unit 1050 that is a non-transitory storage device of the computer. Then, at the time of performing processing, the computer loads the program stored in the auxiliary recording unit 1050 that is the non-transitory storage device of the computer into the storage unit 1020 and performs processing in accordance with the loaded program. In addition, as another embodiment of the program, the computer may directly load the program from the portable recording medium into the storage unit 1020 and perform processing in accordance with the program, and furthermore, the computer may sequentially perform processing in accordance with a received program each time the program is transferred from the server computer to the computer. Moreover, the above-described processing may be executed by a so-called application service provider (ASP) type service that implements a processing function only by an execution instruction and result acquisition without transferring the program from the server computer to the computer. Note that the program in the present embodiment includes information that is used for processing by an electronic computer and is equivalent to the program (data or the like that is not a direct command to the computer but has property that defines processing performed by the computer).

Although the present devices are each configured by performing a predetermined program on a computer in the present embodiment, at least part of the processing content may be implemented by hardware.

In addition, it is needless to say that modifications can be appropriately made without departing from the gist of the present invention.

1. A cancellation device comprising:
processing circuitry configured to generate a cancellation signal for suppressing noise acquired by one or more reference microphones for acquiring noise; and
one or more cancellation loudspeakers configured to emit sound on the basis of the cancellation signal,
wherein the processing circuitry generates the cancellation signal on the basis of sound signals obtained by one or more error microphones disposed in a region where noise is desired to be suppressed, and
the one or more reference microphones have directivity and are disposed in the vicinity of the cancellation loudspeakers.

2. The cancellation device according to claim 1,
wherein the one or more cancellation loudspeakers are enclosure-less loudspeakers.

3. The cancellation device according to claim 1,
wherein the number of the one or more reference microphones is one, and
the reference microphone has directivity in a direction in which sound coming from the one or more cancellation loudspeakers is weaker than in a direction in which sound coming from the one or more cancellation loudspeakers is strong.

4. The cancellation device according to claim 1,
wherein the number of the one or more reference microphones is two or more, some of the one or more reference microphones have directivity in a direction in which sound coming from the one or more cancellation loudspeakers is weaker than in a direction in which sound coming from the one or more cancellation loudspeakers is strong, and
the rest of the one or more reference microphones have directivity in a direction in which the noise arrives.

5. The cancellation device according to claim 1
the processing circuitry further configured to dynamically control the directivity.

6. A cancellation method comprising:
a sound signal processing step of generating, by processing circuitry, a cancellation signal for suppressing noise acquired by one or more reference microphones for acquiring noise; and
a sound emitting step of emitting, by the processing circuitry, sound on the basis of the cancellation signal,
wherein the sound signal processing step includes generating the cancellation signal on the basis of sound signals obtained by one or more error microphones disposed in a region where noise is desired to be suppressed, and
the one or more reference microphones have directivity and are disposed in the vicinity of the cancellation loudspeakers.

7. A non-transitory computer readable medium that stores a program for causing a computer to perform each step of the cancellation method according to claim 6.
